(19) United States
(12) Patent Application Publication
(10) Pub. No.: US 2019/0314907 A1
(43) Pub. Date: Oct. 17, 2019

(54) MILLING CUTTER WITH CARTRIDGE AND AN ENHANCED CARTRIDGE FASTENING MEANS THEREFOR

(71) Applicant: Suryadi SANTOSO, Jakarta (ID)

(72) Inventor: Suryadi SANTOSO, Jakarta (ID)

(21) Appl. No.: 16/461,934

(22) PCT Filed: Jun. 8, 2017
(86) PCT No.: PCT/ID2017/000002

§ 371 Date: May 17, 2019

(30) Foreign Application Priority Data
Dec. 27, 2016 (ID) S-00201608995

(51) Int. Cl. B23C 5/24

(52) U.S. Cl. CPC B23C 5/241; B23C 2270/06; B23C 5/2462

(57) ABSTRACT

The present invention provides a milling cutter with higher rigidity resulted from the design of aperture in the cartridge body and the fastening means of cartridge to the riffling cutter body. The fastening means comprises a fastening bolt mounted to the cartridge at the contact angle of bolt-to-cartridge of less than 90 degrees. The cartridge body has an aperture with oval or oblong shape that allows expansion and/or deformation to occur in the cartridge body during fastening operation to provide a solid or rigid fastening on the milling cutter body.

### FIELD OF THE INVENTION

The present invention relates to a milling cutter. More specifically, the present invention relates to a fastening means to fasten a cartridge to a milling cutter body.

### BACKGROUND OF THE INVENTION

A milling cutter (or face milling cutter) is commonly used in a milling machine. The main function of the milling cutter is to refine the surface of a workpiece and to thereby generate a relatively smooth surface.

A milling cutter has at least one cutting blade. In most of the milling cutter systems, the cutting blade is mounted on a cartridge body, The body of a milling cutter may accommodate a number of cartridges, each of which comprises a cutting blade; the cartridges are provided diametrically in several hollow sections at the outer surface are in the circumferential direction.

The cartridge which holds a cutting blade is mounted on the milling cutter body in several ways. The most common way is to use fastening bolt.

The advantage of the use of cartridge systems is that in the event of wear or damage occurred on the cutting blade, then the damaged cutting blade cap simply be removed and then replaced by the new one, By this principle, the milling cutter body tan still be used, although any of the cutting blades have been changed or replaced repeatedly.

The milling cutter is run by rotating the drive shaft (spindle) at a certain rotation speed with a certain rotation direction and the feeding action is conducted in a certain direction against the material being processed.

The disadvantage of a cartridge system is reduced rigidity of the cutting blade relative to the milling cutter body. In such instance, rigidity is reduced since the cutting blade is a separate part of the milling cutter body and it is joined to the milling cutter body through several other components including cartridge.

A means for joining the cartridge comprising a cutting blade to the body of the milling cutter will greatly influence the rigidity and performance of a cutting blade during in operation. The low rigidity will lead to:
1. the increasingly higher vibration when cutting is made on the workpiece material
2. increasingly noisy when performing cutting operations
3. the increasingly rough surfaces
4. shorter service-life of the cutting blade.

A commonly used joining system for the cartridge to the milling cutter body comprises the use of bolt type fastener wherein the lower surface of the bolt head is perpendicular to the longitudinal direction of the bolt, as illustrated in FIG. 6.

In this manner, the fastening bolt can provide a compressive force to only one direction, while the cartridge engages more than one contact surface to the milling cutter body. On the other contact surfaces, there are no active forces that bind the cartridge to the milling cutter body, causing the possibility of vibration on either surface that does not receive such active force. To obtain a high rigidity of a joint between cartridge and milling cutter body, more surface(s) need to receive compressive forces provided by this fastening bolt.

In other cases, as shown in FIG. 7, the fastening bolt is screwed into the cartridge at a certain slope so that the compressive forces is divided into two directions from the cartridge to the milling cutter body. By this system, the fastening bolt actively provides compressive force on two contact surfaces between the cartridge and the milling cutter body. In this case, the level of rigidity is better than the system in FIG. 6, but there is still at least one more contact surface not receiving active compression force when the fastening bolt is tightened. By using fastening bolt that has a contact angle of bolt-to-cartridges of 90 degrees, it is not possible to provide compressive forces on more than two contact surfaces by one bolt only.

A method or means is needed for more effective fastening to tighten or fasten the cartridge to the body of the milling cutter, including selection of the type and design of fastener or bolt, in order to obtain maximum rigidity.

### BRIEF DESCRIPTION OF INVENTION

In view of the disadvantages commonly found in the prior arts as described above, the present inventor has been trying to find ways to improve the fastening means to get a higher rigidity to the milling cutter entirely.

The present inventor has identified that a certain type of bolt that is screwed into the cartridge at a certain contact angle of bolt-to-cartridge (α), accompanied with a design on the shape of certain aperture in the cartridge body which is in contact with the fastening bolt, unexpectedly results in a better rigidity to the milling cutter.

Accordingly, the inventor has accomplished the work and providing a milling cutter with a higher rigidity that comprises:
a cylindrical shaped milling cutter body, which has on its upper end surface thereof a central hole and a recess to accommodate a drive shaft;
at least one hollow section provided diametrically around the lower end of the milling cutter body;
at least one cartridge installed in the hollow section around milling cutter body, each of which comprises a cartridge body and a cutting blade;
at least one adjusting wedge and one adjusting screw being screwed in the hollow sections, where the adjusting screw is mounted on the adjusting wedge and penetrate into the milling cutter body that serves to regulate the height of the cartridge;
a fastening means for fastening tightly each cartridge into each hollow section of the milling cutter body;
characterized in that the fastening means comprises a fastening bolt that is mounted to the cartridge at the contact angle of bolt-to-cartridge of less than 90 degrees.

In a preferred embodiment, there is provided a fastening means for a milling cutter wherein the fastening bolt mounted to the cartridge has a contact angle of bolt-to-cartridges in the range of between 15 to 70 degrees, preferably between 17 to 55 degrees, and most preferably between 20 to 45 degrees.

In a preferred embodiment, the type of bolt to be used is a fastening bolt having a generally cone-shaped head, wherein the diameter of upper portion of the cone is greater than the diameter of the lower portion thereof.

In a preferred embodiment, there is provided a milling cutter as described above which is further characterized in that the cartridge body has an aperture that is formed in such a shape that allows expansion and/or deformation to occur along the cartridge body during fastening action to give a robust fastening over milling cutter body. In a preferred embodiment, the aperture is oval or oblong in shape that can accommodate the flat portion of the fastening bolt and slope portion of the fastening bolt head. More preferably, the length in horizontal direction of the flat portion of fastening bolt and slope portion of the fastening bolt head are adjusted to obtain optimum compressive forces to the various surfaces of the milling cutter body.

Embodiments disclosed herein are merely illustrative examples. Modifications can be understood by a person skilled in the art to implement a fastening means for cartridge along with cutting blade into the milling cutter body. Type of cartridges that can be fastened to the milling cutter body can be varied and each cartridge can include a wide range of cutting blades depending on the respective special purposes.

### BRIEF DESCRIPTION OF DRAWINGS

FIG. 1 shows a perspective view of the milling cutter according to the present invention.

FIG. 2 shows bottom view of the milling cutter according to the present invention.

FIG. 3 shows a perspective view of the milling cutter according to the present invention, particularly showing the direction of rotation of milling cutter body and direction of feeding of the workpiece.

FIG. 4 shows a side view of a milling cutter according to FIG. 3.

FIG. 5 shows a top view of a milling cutter according to FIG. 3.

FIG. 6 shows a fastening means for the cartridge to the milling cutter body according to the prior art, where the fastening bolt is screwed in such a direction that only provide a compressive force to single surface of the milling cutter body.

FIG. 7 shows a fastening means for the cartridge to the milling cutter body according to the prior art, in which the fastening bolt is screwed into the cartridge at a certain slope so that the compressive force is divided into two directions on surfaces of the milling cutter body.

FIG. 8 shows the fastening means for the cartridge to milling cutter body according to the present invention, wherein the fastening bolt is mounted at a contact angle of bolt-to-cartridges of less than 90 degrees.

### DETAILED DESCRIPTION OF INVENTION

Throughout the description and claims of the present invention, by the contact angle of bolt-to-cartridge (α) is meant an angle formed by the horizontal axis of the fastening bolt (i.e. longitudinal direction of the bolt) and the slope of the surface of the head of fastening bolt.

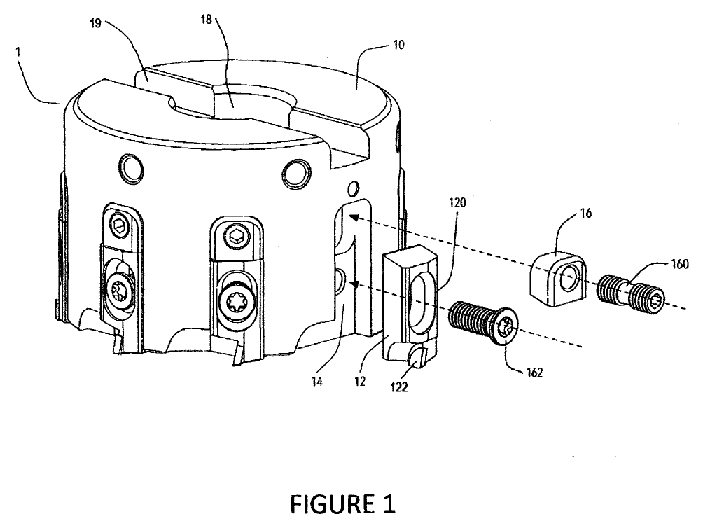

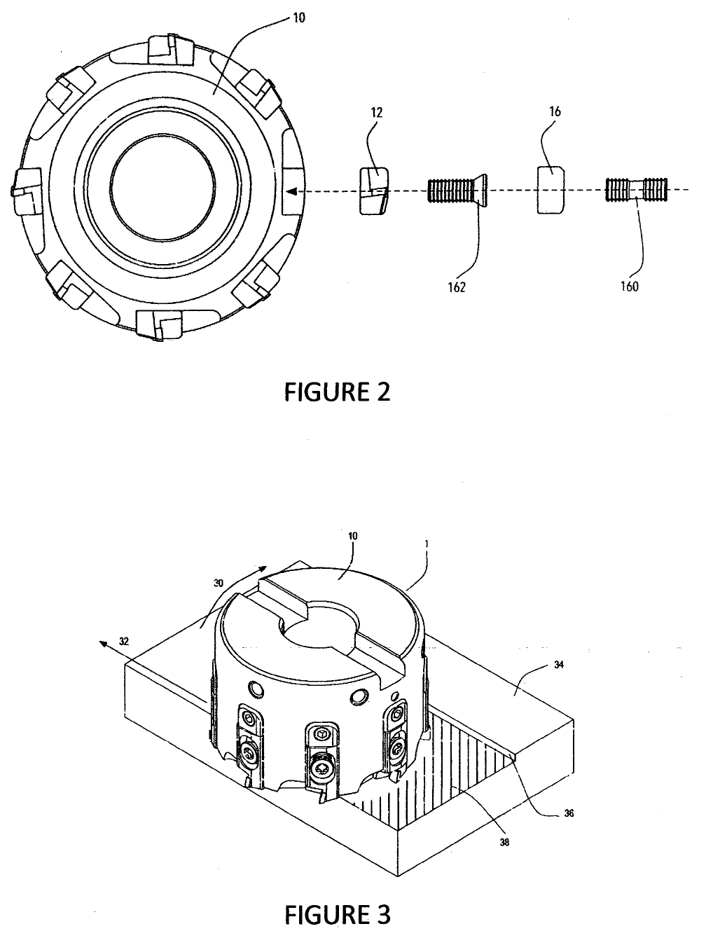

Referring to FIG. 1 to FIG. 8, milling cutter (1) according to the present invention has several parts including a milling cutter body (10) which is cylindrical in shape and having a center hole (18) and a recess (19) for loading a drive shaft, a number of hollow sections (14) around the milling cutter body (10) to accommodate at least one cartridge (12). The width of the cartridge (12) is made at right precision to fit the width of the hollow section (14). Each cartridge (12) has a cartridge body (120) and a cutting blade (122). The cartridge (12) is connected to the milling cutter body (10) by a fastening means to fasten tightly at least one cartridge (12) into at least one hollow section (14) of the milling cutter body (10). This fastening means is assisted by a adjusting wedge (16) and adjusting screw (160). Adjusting screw (160) which is mounted onto adjusting wedge (16) penetrates into the milling cutter body (10) and serves to adjust the vertical position or height of the cartridge (12) as appropriate.

The number of hollow sections (14) provided diametrically in a milling cutter body (10) may be two, four, six, eight and so forth depending on the need and capacity of the milling cutter body (10).

Cutting blade (122) in this application can be made of various materials, such as polycrystalline diamond (PCD), tungsten carbide, ceramic-metallic material (cermet), or high speed steel (HSS). Cutting blade has a sharp edge that serves to cut, and have angles of relief at the back side thereof, so there is no friction between the cutting blade and the workpiece, after the cutting process occurs. The detail of cutting blade (122) is not given in the description here since the present invention will focus only to fastening means of the cartridge to milling cutter body (10).

The fastening means of the present invention comprises a fastening bolt (162) having threaded surface along its length and is removably (detachably) mounted to the corresponding threaded holes (820) to fasten the cartridge (12) to the milling cutter body (10) to obtain a high rigidity.

The fastening bolt (162) has a generally cone-shaped head, wherein the diameter of upper portion of the cone is greater than the diameter of the lower portion thereof. The flat trunk portion of the fastening bolt (162) is threaded and the thread ends up at the ramped section entering the head portion of the bolt. The fastening bolt (162) is typically made of an appropriate metal.

Adjusting wedge (16) and adjusting screw (160) serve to make the adjustment of the height of the cartridge in the vertical direction. Adjusting screw (160) can be loosened and moved up and down along the vertical axis, and is tightened in order to obtain an adequate fastening effect to improve the rigidity of the entire system.

Cartridge body (120) has an aperture (124) in such a form that expansion and/or deformation may occur in the cartridge body (120) during fastening to provide a robust fastening over the milling cutter body (10). In a preferred embodiment, the aperture (124) is elongated oval- or oblong-shaped to accommodate the flat portion (840) of fastening bolt (84) and a slope portion (842) of the fastening bolt (84). Such elongated oval or oblong shape of the aperture (124) will allows those parts closest to the point of contact between the fastening bolt (84) and aperture (124) to be deformed and/or expanded in advance of the other parts which are relatively away from the contact point.

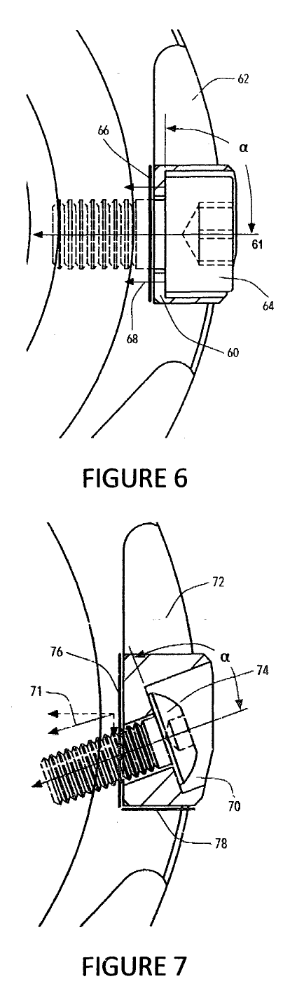

Referring to FIG. 6, it is shown a fastening means of the cartridge (60) to the body of milling cutter (62) according to the prior art, in the direction of the fastening (61), wherein the fastening bolt (64) is screwed in the direction that will only provide a compressive force to a single surface (66) of the milling cutter body (62). Fastening bolt (64) can provide a compressive force to merely one direction (68), while the cartridge (60) is in contact with more than one contact surface with the milling cutter body (62). The more contact surfaces that can receive compressive forces provided by fastening bolt, the higher rigidity between the cartridge (60) and the milling cutter body (62) supposed to be resulted. Meanwhile, on the other contact surfaces, there is no active force that fasten the cartridge (60) to the milling cutter body (62), giving rise to the possibility of vibration on those contact surfaces that do not have the active forces.

FIG. 7 shows the fastening means for the cartridge (70) to the body of milling cutter (72) according to prior art, in which the fastening bolt (74) of the same type as used in FIG. 6 is mounted on a certain slope so that the compressive force is divided into two directions of both contact surfaces (76, 78) of milling cutter body (72). In this way, the fastening bolt (74) will actively provide compressive force on 2 (two) contact surfaces between the cartridge (70) and the milling cutter body (72). In general, such conditions will provide a level of rigidity which is better than the system in FIG. 6, but there is still at least one more contact surface that does not have an active compressive force (71) when the fastening bolt (74) is tightened. By using the fastening bolt (74) which has a contact angle of bolt-to-cartridge (α) of 90 degrees, it is not possible to provide compressive force (71) to more than two contact surfaces if utilizing one fastening bolt (74) only.

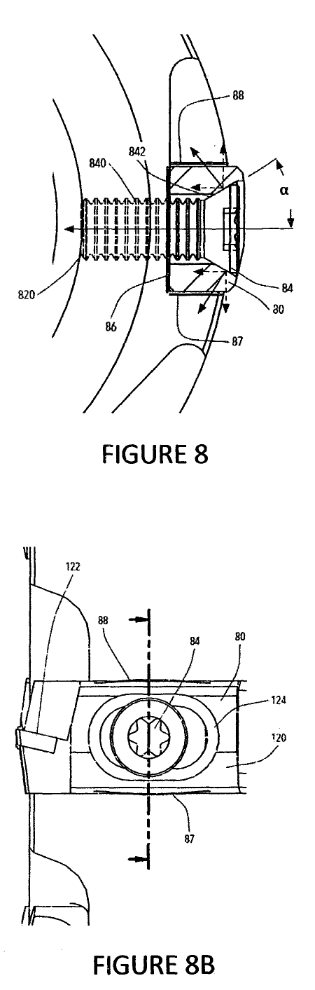

According to the invention, as illustrated in FIG. 8, the enhanced fastening means for binding the cartridge (80) to the body of milling cutter (82) here is implemented using a fastening bolt (84) which has a contact angle of bolt-to-cartridge (α) of less than 90 degrees.

In a preferred embodiment, a fastening means for a milling cutter is provided wherein the fastening bolt (84) has a contact angle of bolt-to-cartridge in the range of between 15 to 70 degrees, preferably between 17 to 55 degrees, and most preferably between 20 to 45 degrees.

In such arrangement, the fastening bolt (84) can provide active compressive forces on at least three contact surfaces simultaneously (86, 87, 88) using only one fastening bolt (84) (FIG. 8A and 8B). In addition to using the contact angle of the bolt-to-cartridge (α) of less than 90 degrees, as is obvious in FIG. 8A, the means can only function properly when cooperating with the cartridge body (80) which is designed such that allowing it to be deformed or expanded laterally to two directions (87, 88) when the) fastening bolt (84) is lightened. Lateral deformation or expansion in two directions (87, 88) is facilitated by the availability of the aperture (124) in oval or oblong shape to accommodate the flat portion (840) of fastening bolt (84) and a part of slope portion (842) of the fastening bolt (84).

Deformation or expansion of the cartridge body (80) is actively promoting axial compressive force of the fastening bolt (84) to both sides of edges (87, 88) of the cartridge body (80) which is in contact with the milling cutter body (10).

The arrangement results in active compressive forces for at least three sides (86, 87, 88) with one fastening bolt (84) only, so that the level of rigidity increases relative to the prior art that is commonly used for joining the cartridge body (80) with the milling) cutter body (10).

The length in horizontal direction of the flat portion (840) of fastening bolt (84) and slope portion (842) of fastening bolt (84) is managed appropriately so as to obtain optimum compressive forces to the various contact surfaces of the milling cutter body (10) when the fastening bolt (84) is tightened.

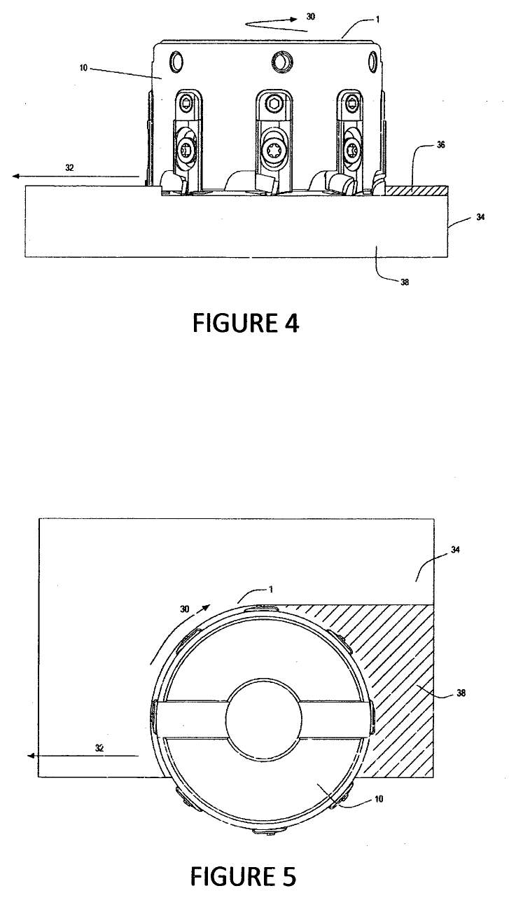

FIG. 3 indicates the situation of milling cutter (1) according to the present invention which is under operation, especially the arrow indicating the direction of rotation (30) of milling cutter body (10) and the arrow showing the direction of feeding (32) of the workpiece (34), it is also easily understood from this figure regarding thickness of the pieces (36) and the shaded area indicates the area that has already been milled (38). FIG. 4 and FIG. 5 is each another view of the circumstances described in FIG. 3.

What is claimed is:

1. A milling cutter for smoothing a workpiece, which comprises:
a cylindrical shaped milling cutter body, which has on its upper end surface thereof a central hole and a recess to accommodate a drive shaft;
at least one hollow section provided diametrically around the lower end of the milling cutter body;
at least one cartridge being installed at the hollow sections around the milling cutter body, each of which comprises a cartridge body and a cutting blade;
at least one adjusting wedge and one adjusting screw being screwed in the hollow sections, where the adjusting screw is mounted on the adjusting wedge and penetrate into the milling cutter body, that serves to regulate the height of the cartridge;
a fastening means for fastening tightly each cartridge into each hollow section of the milling cutter body;
characterized in that the fastening means comprises a fastening bolt which has a generally cone-shaped head, the diameter of upper portion of the cone is greater than the diameter of the lower portion thereof;
the fastening bolt is mounted to the cartridge at a contact angle of bolt-to-cartridge of less than 90 degrees; and
the cartridge body has an aperture of oblong shape with at least 2.0 mm of cartridge axial adjustment range that allows expansion and/or deformation to occur in the cartridge body when the fastening bolt is tightened, and that allows cutting blade to be adjusted axially to a uniform height prior to use, after blade re-sharpening.

2. The milling cutter according to claim 3, characterized in that the said fastening bolt mounted to the cartridge has a contact angle of bolt-to-cartridge (α) in the range of 20-45 degrees.

3. The milling cutter according to claim 1, wherein the said fastening bolt provides active compressive forces that comprising forward force and lateral forces to at least three contact surfaces of the inner side of the hollow sections of milling cutter body.

4. The milling cutter according to claim 1, wherein an axial adjustment on the cartridge allows for the cutting blade to be re-sharpened for more than one time.

5. The milling cutter according to claim 1, wherein the re-sharpening of said single cutting blade further allows for all cutting blades affixed to least one cartridge to be mounted in the milling cutter body at a uniform height.

6. The milling cutter according to claim 1, wherein the aperture of oblong shape gives movement space to the head of fastening bolt during the axial adjustment on the cartridge, providing much less bending stress and fatigue on the head of fastening bolt.
